(19) United States
(12) Patent Application Publication
(10) Pub. No.: US 2024/0385309 A1
(43) Pub. Date: Nov. 21, 2024

(54) METHOD AND SYSTEM FOR ULTRA-WIDEBAND TWO-WAY RANGING

(71) Applicant: Qorvo US, Inc., Greensboro, NC (US)

(72) Inventor: Billy Verso, Maynooth (IE)

(21) Appl. No.: 18/640,265

(22) Filed: Apr. 19, 2024

Related U.S. Application Data
(60) Provisional application No. 63/503,009, filed on May 18, 2023.

(51) Int. Cl. G01S 13/76; G01S 13/79

(52) U.S. Cl. CPC G01S 13/765; G01S 13/79

(57) ABSTRACT

A method for channel impulse response (CIR) validation for two-way ranging (TWR) in an ultra-wide band (UWB) communication system. The method includes: transmitting, by a first UWB device, a first cipher code; generating, by a second UWB device, a first CIR computed from an accumulation of the first cipher code; transmitting, by the second UWB device, a second cipher code in response to receiving the first cipher code; generating, by the first UWB device, a second CIR computed from an accumulation of the second cipher code; and comparing, by one of the first UWB device or the second UWB device, the second CIR with the first CIR.

### FIELD OF THE DISCLOSURE

This application claims priority to U.S. Provisional Patent Application No. 63/503,009 filed May 18, 2023, which is incorporated by reference herein in its entirety.

### FIELD OF THE DISCLOSURE

The present disclosure relates to wireless communication systems and methods, and, in particularly, to a system and a method for ultra-wideband (UWB) two-way ranging (TWR).

### BACKGROUND

In current wireless communication systems, time-of-flight (TOF) is often employed to determine the distance between two devices/nodes in a UWB two-way ranging (TWR) system. The veracity of UWB TWR results is an area of focus at standards bodies like IEEE and the FiRa Consortium. To improve the security of the communication, a scrambled timestamp sequence (STS) is generated cryptographically and is included in the packet. However, having an STS is not in itself sufficient to ensure that the receival (RX) timestamps and resultant TWR are secure. Additional measures are needed to ensure that an attacker has not interfered with the signal to cause a false early peak to be induced in the channel impulse response (CIR) to foreshorten the TOF result. Although efforts have been made to validate the CIR and TOF to some extent, the security of UWB TWR still needs to be improved.

Therefore, there is a need for a UWB system and a corresponding method for operation with improved the security of TWR and the TOF measurement.

### SUMMARY

Embodiments of the disclosure provide a method for channel impulse response (CIR) validation for two-way ranging (TWR) in UWB communication system. The method includes: transmitting, by a first UWB device, a first cipher code; generating, by a second UWB device, a first CIR computed from an accumulation of the first cipher code; transmitting, by the second UWB device, a second cipher code in response to receiving the first cipher code; generating, by the first UWB device, a second CIR computed from an accumulation of the second cipher code; and comparing, by one of the first UWB device or the second UWB device, the second CIR with the first CIR.

In some embodiments, the method further includes: in response to a similarity between the first CIR and the second CIR being equal to or above a similarity threshold value, one of the first UWB device or the second UWB device accepts a time-of-flight (TOF) between the first UWB device and the second UWB device computed from the second cipher code; and in response to the similarity between the first CIR and the second CIR being below the similarity threshold value, the one of the first UWB device and or the second UWB device rejects the TOF.

In some embodiments, the method includes transmitting, by the second UWB device, the second cipher code and the first CIR in separate packet. The first UWB device compares the second CIR with the first CIR.

In some embodiments, the method includes transmitting, by the second UWB device, the second cipher code and the first CIR in a same packet. The first UWB device compares the second CIR with the first CIR.

In some embodiments, the method further includes transmitting, by the first UWB device, the second CIR computed to the second UWB device. The second UWB device compares the second CIR with the first CIR.

In some embodiments, the method includes comparing, by the one of the first UWB device or the second UWB device, a first separation between a first peak and a second peak of the first CIR with a second separation between a first peak and a second peak of the second CIR. The similarity threshold value includes a predetermined percentage of the second separation.

In some embodiments, the first peak of each of the first CIR and the second CIR represents a first path peak; and the second peak of each of the first CIR and the second CIR represents a reflection path peak of a same time location.

In some embodiments, the method includes comparing, by the one of the first UWB device or the second UWB device, a first ratio between a strength of a first peak and a strength of a second peak of the first CIR with a second ratio between a strength of a first peak and a strength of a second peak of the second CIR. The similarity threshold value includes a predetermined percentage of the second ratio.

In some embodiments, the first peaks of the first CIR and the second CIR correspond to a same first time location; and the second peaks of the first CIR and the second CIR correspond to a same second time location.

In some embodiments, the method includes comparing, by the one of the first UWB device or the second UWB device, a contour of the first CIR with a contour of the second CIR. The similarity threshold value includes a predetermined percentage of a contour line that covers the second CIR.

In some embodiments, the method includes generating, by the one of the first UWB device or the second UWB device, the contour line that completely covers the second CIR; normalizing, by the one of the first UWB device or the second UWB device, the first CIR such that a first peak of the first CIR aligns with a first peak of the second CIR; and mapping, by the one of the first UWB device or the second UWB device, the first CIR into the contour line.

In some embodiments, the similarity threshold value further includes a second predetermined percentage of a second contour line that covers the first CIR. The method further includes: generating, by the one of the first UWB device or the second UWB device, the second contour line that completely covers the first CIR; normalizing, by the one of the first UWB device or the second UWB device, the second CIR such that the first peak of the second CIR aligns with the first peak of the first CIR; and mapping, by the one of the first UWB device or the second UWB device, the second CIR into the second contour line.

In some embodiments, the method includes: computing, by the one of the first UWB device or the second UWB device, a normalized cross-correlation value between the first CIR and the second CIR; and comparing, by the one of the first UWB device or the second UWB device, the normalized cross-correlation value with the similarity threshold value. The similarity threshold value is a predetermined threshold correlation value.

In some embodiments, the method further includes reducing a size of the first CIR before transmitting the first CIR, wherein a reduction of the size includes at least one of data compression, discarding a noise portion of the first CIR, or pre-computing a magnitude of the first CIR.

Embodiments of the present disclosure provide a UWB device for TWR. The UWB device includes a transceiver operable to perform a UWB communication, and a memory for storing program instructions, cipher codes, and channel-impulse responses accumulated from the cipher codes. The UWB device also includes a processor coupled to the transceiver and to the memory. The processor is operable to execute the program instructions, which, when executed by the processor, cause the UWB device to perform the following operations: transmitting a first cipher code to another UWB device; receiving a second cipher code from the other UWB device as a response to the first cipher code; and generating a CIR based on an accumulation of the second cipher code.

In some embodiments, the UWB device further includes: receiving another CIR from the other UWB device, the other CIR being computed from an accumulation of the first cipher code by the other UWB device; and comparing the CIR with the other CIR.

In some embodiments, the UWB device further includes transmitting the CIR to the other UWB.

In some embodiments, the processor is further configured to: in response to a similarity between the other CIR and the CIR being equal to or above a similarity threshold value, accept a time-of-flight (TOF) to the other UWB device computed from the CIR; and in response to the similarity between the CIR and the other CIR being below the similarity threshold value, reject the TOF.

In some embodiments, the processor is configured to compare a first separation between a first peak and a second peak of the other CIR with a second separation between a first peak and a second peak of the CIR. The similarity threshold value includes a predetermined percentage of the second separation.

In some embodiments, the processor is configured to compare a first ratio between a strength of a first peak and a strength of a second peak of the other CIR with a second ratio between a strength of a first peak and a strength of a second peak of the CIR. The similarity threshold value includes a predetermined percentage of the second ratio.

In some embodiments, the processor is configured to compare a contour of the other CIR with a contour of the CIR. The similarity threshold value includes a predetermined percentage of a contour line that covers the CIR.

In some embodiments, the processor is configured to: generate the contour line that completely covers the CIR; normalize the other CIR such that a first peak of the other CIR aligns with a first peak of the CIR; and map the other CIR into the contour line.

In some embodiments, the similarity threshold value further includes a second predetermined percentage of a second contour line that covers the other CIR, the processor is further configured to: generate the second contour line that completely covers the other CIR; normalize the CIR such that the first peak of the CIR aligns with the first peak of the other CIR; and map the CIR into the second contour line.

In some embodiments, the processor is configured to: compute a normalized cross-correlation value between the other CIR and the CIR; and compare the normalized cross-correlation value with the similarity threshold value, wherein the similarity threshold value is a predetermined threshold correlation value.

Embodiments of the present disclosure provide a method for CIR validation for TWR in a UWB communication system. The method includes: transmitting a first cipher code to a UWB device; receiving a first CIR and a second cipher code from the UWB device, the first CIR being computed from an accumulation of the first cipher code by the UWB device; generating a second CIR based on an accumulation of the second cipher code; comparing the second CIR with the first CIR; in response to a similarity between the first CIR and the second CIR being equal to or above a similarity threshold value, accepting a time-of-flight (TOF) to the UWB device; and in response to the similarity between the first CIR and the second CIR being below the similarity threshold value, rejecting the TOF.

Embodiments of the present disclosure provide a method for CIR validation for TWR) in an ultra-wide band (UWB) communication system. The method includes: receiving, from a UWB device, a first cipher code; generating a first CIR corresponding to characteristics of a UWB channel from an accumulation of the first cipher code; and transmitting, to the UWB device, a second cipher code in response to receiving the first cipher code.

Embodiments of the present disclosure provide a method for CIR validation for TWR in an ultra-wide band (UWB) communication system. The method includes: transmitting a first cipher code to a UWB device; receiving a second cipher code from the UWB device; and generating a first CIR corresponding to characteristics of a UWB channel from an accumulation of the second cipher code.

Embodiments of the present disclosure provide a UWB device for TWR. The UWB device includes a transceiver operable to perform a UWB communication, a memory for storing program instructions, cipher codes, and channel-impulse responses accumulated from the cipher codes, and a processor coupled to the transceiver and to the memory. The processor is operable to execute the program instructions, which, when executed by the processor, cause the UWB device to perform the following operations: receiving, from another UWB device, a first cipher code; generating a first CIR corresponding to characteristics of a UWB channel from an accumulation of the first cipher code; and transmitting, to the other UWB device, a second cipher code in response to receiving the first cipher code.

Embodiments of the present disclosure provide a UWB device for TWR. The UWB device includes a transceiver operable to perform a UWB communication, a memory for storing program instructions, cipher codes, and channel-impulse responses accumulated from the cipher codes, and a processor coupled to the transceiver and to the memory. The processor is operable to execute the program instructions, which, when executed by the processor, cause the UWB device to perform the following operations: transmitting a first cipher code to another UWB device; receiving a second cipher code from the other UWB device; and generating a first CIR corresponding to characteristics of the UWB channel from an accumulation of the second cipher code.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates an exemplary UWB TWR system including a UWB device and an exemplary on-board computer, according to some aspects of the present disclosure.

FIG. 1B illustrates an architecture of an exemplary UWB device, according to some aspects of the present disclosure.

FIG. 1C illustrates an architecture of an exemplary on-board computer, according to some aspects of the present disclosure.

FIGS. 2A-2C each illustrates a single-sided (SS) TWR between two UWB devices, according to some aspects of the present disclosure.

FIGS. 2D and 2E each illustrates a double-sided TWR between two UWB devices, according to some aspects of the present disclosure.

FIGS. 3A-3C each illustrates a UWB frame structure with a scrambled timestamp sequence (STS), according to some aspects of the present disclosure.

FIG. 4A shows a CIR computed by a cipher accumulator, according to some aspects of the present disclosure.

FIGS. 4B-4D each illustrates a comparison of CIR's in a CIR validation process, according to some aspects of the present disclosure.

FIG. 5A illustrates an exemplary method of CIR validation in a UWB TWR system, according to some aspects of the present disclosure.

FIG. 5B illustrates an exemplary method for CIR validation by a UWB device, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second clement could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using UWB is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several hundreds of MHz to several GHz or more, low spectral density, and short pulse width (e.g., 2 nanoseconds to 500 picoseconds) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled device” or simply as “UWB device”).

As used herein, the term “accumulating a cipher code” or the like refers to accumulating the result of cross correlating the received sequence of chips with a locally generated version of the sequence, which is generated by the receiver knowing the shared secret key/seed used by the transmitter.

In this disclosure, a UWB device may receive a computed CIR along with other data from another UWB device and used the other data to compute a time-of-flight (TOF). For example, the UWB device may receive transmitter (TX) and receiver (RX) timestamps from the transmission and reception of a cipher code. A received timestamp may be obtained from finding the first arriving pulse/ray in a CIR, which is what a potential attacker is trying to make appear earlier. Either the timestamps, or the calculated reply time, and/or the round-trip time as appropriate may be sent to whichever end (e.g., UWB device) is doing the TOF calculation. The UWB device can calculate the TOF, e.g., in a single-sided TWR as ½ (T_{round}-T_{reply}). In various embodiments, a correction for clock offset is also included in the TOF calculation.

As previously mentioned, STS is a sequence of pseudo-randomized pulses generated using an Advanced Encryption Standard (AES)-128 based deterministic random bit generator (DRBG). Only valid transmitters and receivers know the seed to generate the sequence for transmission and for reception to cross correlate and accumulate to produce a channel impulse response estimate from which to determine the receive timestamp. Some patent applications have introduced some methods to validate the CIR and TOF to some extent, e.g., U.S. Patent Publication No. US2022/0239532, and the methods/checks described therein are valid and can also be applied. These essentially are checks that the CIR signal and other metrics are consistent with normal operation, and if not, to reject the ranging TOF result, irrespective of the cause. However, the existing checks may not provide sufficient security if an attacker induces false early peak in the CIR.

Embodiments of the present disclosure introduces a novel additional security check by validating the CIR based receival timestamp and the TOF result. According to the present disclosure, in a UWB SS TWR system, a first end (e.g., a UWB device) communicates with a second end (e.g., another UWB device or an on-board computer) via TWR. The first end can transmit a first cipher code to the second end, and receive a second cipher code and a CIR from the second end. The CIR is accumulated from the first cipher code by the second end. The first end then validates the receival timestamp and the TOF result from the second end by comparing the CIR accumulated by the second end with the CIR accumulated by itself (e.g., the first end). If the similarity between the two CIR's is sufficiently high, the first end accepts the receival timestamp and the TOF result. If the similarity does not meet a predetermined threshold, the first end rejects the receival timestamp and the TOF result. To determine the similarity between the two CIR's, various ways of comparison can be used. For example, the two CIR's are compared based on the separation between two peaks of the same time positions (e.g., time delays), the strengths of two peaks of the same time positions, the contours of the two CIR's, and/or the cross-correlation values of the two CIR's. The disclosed validation method can be used independently or can be combined with other existing security checks.

In various embodiments, the CIR and the second cipher code can be sent in a same packet or in separate packets. In some embodiments, the second end does not send the CIR, while the first end sends its accumulated CIR to the second end, such that the second end compares the CIR from the first end with the CIR accumulated by itself. In some embodiments, the CIR validation can also be used in doubled sided (DS) TWR systems. Depending on the implementation, CIR's may be compared once or twice. Details are provided below.

The principle employed for this disclosure is that the RF channel between the first end and the second end should be symmetric, and therefore the two ends, performing a ranging exchange should get the same or a very similar view of the CIR generated by accumulation of the STS. The receival timestamp and the TOF result can only be accepted if the CIR's computed by the two ends are the same or sufficiently similar. An attacker trying to induce false early peak in a CIR will be unable to do so the same in both ends because it cannot physically have the same RF channel into the two separate ends.

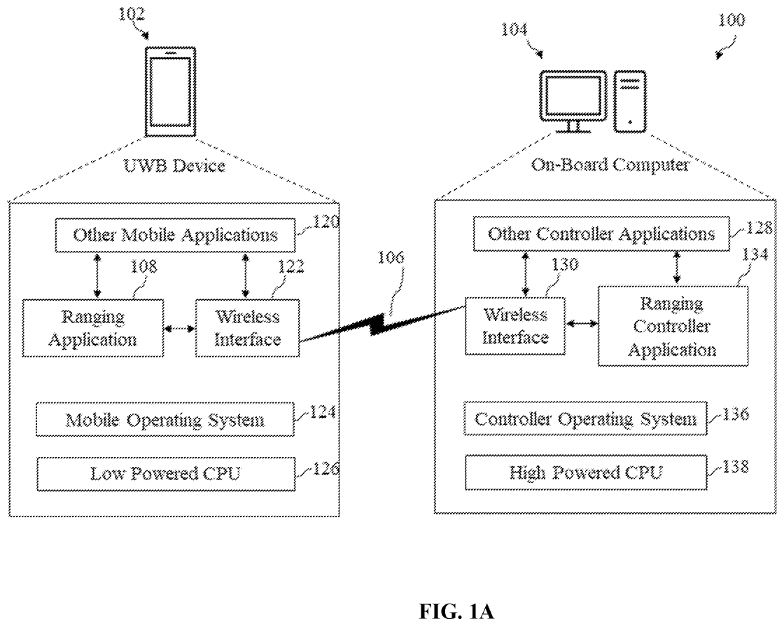

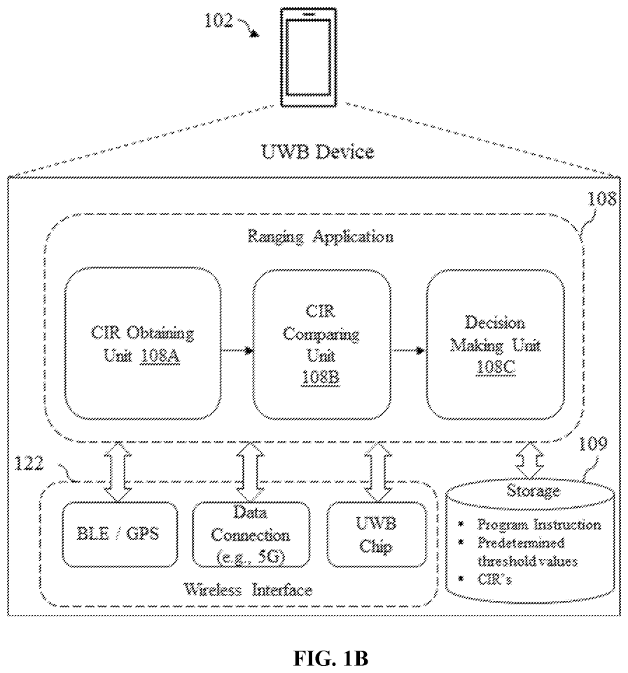

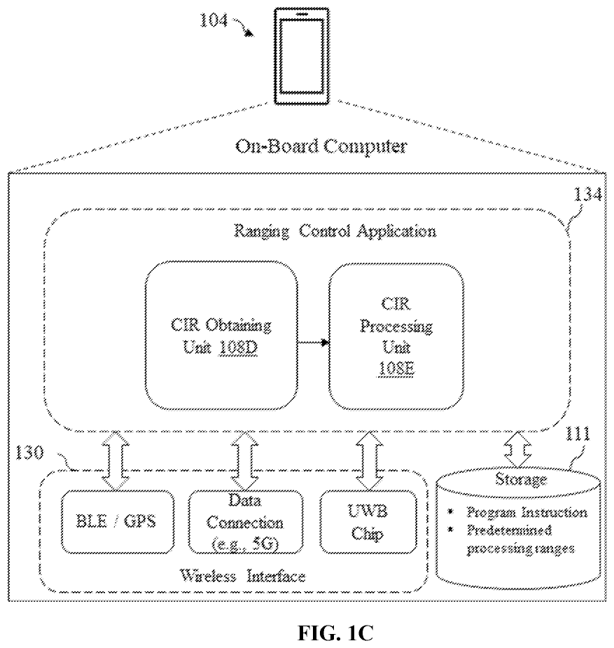

FIG. 1A depicts an exemplary system 100 for implementing the CIR validation in TWR, according to some embodiments of the present disclosure. System 100 may include a UWB device 102 that is in wireless communication with an on-board computer 104, as symbolically illustrated by a wireless link 106. UWB device 102 may be a mobile device. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include smartphones, tablets, and wearable devices. It is observed here that, on-board computer 104 may not have to be a separate computing unit (in hardware or software form) dedicated to carry out the TWR functionality. In one embodiment, the functionality of on-board computer 104 may be implemented in an already-existing physical computing/data processing unit or (nonphysical) server software in a cloud. In an embodiment, the functionality of on-board computer 104 also includes an application server for TWR of UWB device 102. In an embodiment, on-board computer 104 represents the computing part of another UWB device, which is similar to UWB device 102 (e.g., a mobile device having ranging functions). Wireless link 106 may include a UWB communication interface. Wireless link 106 may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

A ranging application 108 is one of the mobile applications installed in UWB device 102. In addition to the ranging application 108, UWB device 102 may also have one or more other mobile applications 120 reside therein. Other mobile applications 120 are software modules that may have been pre-packaged with the UWB device 102 or may have been downloaded by a user into the memory (not shown) of the UWB device 102. Other mobile applications 120 may be more user-interactive applications, whereas some other mobile applications, such as the ranging application 108, may be less user-interactive in nature. Mobile applications 120 as well as the ranging application 108 may be executed by a processor 126 under the control of the mobile operating system 124. Because of the battery-powered nature of mobile devices, processor 126 may be designed to conserve battery power, such as a relatively low-powered Central Processing Unit (CPU). UWB device 102 may further include a wireless interface 122 to facilitate wireless communication with the on-board computer 104 via the wireless link 106. The applications 108, 120 may utilize the wireless interface 122 as needed.

On-board computer 104 is shown to include a relatively high-powered CPU 138 executing a controller operating system 136. In addition to ranging controller application 134, on-board computer 104 may also store in its memory (not shown) other controller-specific applications 128 such as, for example, an application that facilitates Ethernet-based communication, an application that interacts with the cloud, and the like. On-board computer 104 may wirelessly communicate with the UWB device 102 via its own wireless interface unit 130. Wireless interfaces 122 and 130 may wirelessly transfer data or information between the UWB device 102 and the on-board computer 104 using the wireless link 106 as shown. In some embodiments, when on-board computer 104 represents another UWB device similar to UWB device 102, ranging controller application 134 may perform the same or similar functions as ranging application 108.

Thus, in operation, a device-generated signal or data (e.g., a ranging packet or a data packet) may be wirelessly sent (using the wireless interface 122) over the wireless link 106 to on-board computer 104 for further processing by its CPU 138. Any response or other signal/data from on-board computer 104 can be provided in the device-recognized wireless format by the access control unit's wireless interface 130 and eventually delivered to the UWB device's wireless interface 122 (and, hence, to UWB device's processor 126 for further processing) via the wireless link 106. The resulting wireless “link” 106 between wireless interfaces 122 and 130 is symbolically illustrated by the bi-directional arrow. As discussed above, wireless link 106 may represent a hybrid wireless communication approach that combines UWB communication and one or more wireless communications other than UWB (e.g., Bluetooth, Wi-Fi, and/or cellular data).

FIG. 1B illustrates an exemplary architecture of UWB device 102. As discussed above with respect to FIG. 1A, UWB device 102 includes ranging application 108 as one of the mobile applications installed in the UWB device 102. Ranging application 108 includes a module CIR obtaining unit 108A for computing a CIR, a module CIR comparing unit 108B for comparing CIR's, and a module decision making unit 108C for determining whether the receival timestamp and/or TOF result is to be adopted or discarded. UWB device 102 further includes a wireless interface 122 to facilitate wireless communication with an on-board computer 104 via wireless links. Ranging application 108 may utilize the wireless interface 122 as needed. Wireless interface 122 may facilitate at least bi-directional UWB communication, and in some embodiments, wireless interface 122 represents a hybrid wireless communication approach that combines UWB communication and one or more wireless communications other than UWB (e.g., Bluetooth, GPS, Wi-Fi, and cellular data connection).

For example, the module 108A may utilize a UWB chip in the wireless interface 122 to obtain CIR-related data (e.g., STS) from packets (e.g., ranging packets or data packets) transmitted by on-board computer 104, and perform accumulation to generate an CIR based on the STS. Module 108B may access the CIR accumulated by the on-board computer 104 from the UWB chip and compare the received CIR and the CIR computed by module 108A. Module 108C may make the decision of rejecting or adopting the receival timestamp and/or TOF result based on the comparison result from module 108B. UWB device 102 also includes a storage 109. The storage 109 stores program instructions, which, when executed by a processor of the UWB device 102 causes the UWB device 102 to run ranging application 108 according to the flows illustrated in the signaling diagrams discussed above. Storage 109 also stores predetermined threshold values for CIR comparison/validation, and CIR's computed for current or previous ranging.

In operation, UWB device 102 may be ranging with on-board computer 104. Module 108A may compute an CIR based on the data/ranging packet (e.g., STS) transmitted by on-board computer 104 using accumulation. In some embodiments, module 108A includes a cipher accumulator that generates a first CIR from the STS in a received data/ranging packet from on-board computer 104, using a channel impulse analysis (CIA) algorithm. Module 108A may also access a second CIR received by wireless interface 122. The second CIR may be transmitted by the other UWB device, and may have been processed before transmission to reduce size and facilitate transmission. Module 108A may thus also include suitable software/hardware for processing/recovering the received CIR data from wireless interface 122 such that the recovered CIR (e.g., the second CIR) is ready for processing by ranging application 108. For example, the CIR data received by wireless interface 122 may be compressed, truncated (e.g., by removing a noise portion or a less-of-interest portion of the second CIR data), and/or pre-computed (e.g., by pre-computing and transmitting a magnitude/strength of the second CIR data). Module 108A may be configured to decompress and/or recover the data of the second CIR to a format that can be accepted and processed by ranging application 108.

Module 108B may compare the first CIR and the second CIR to determine the similarity between the two. As will be described in detail below, module 108B may determine the similarity by comparing the separation between two peaks in the two CIR's, comparing the strengths of peaks in the two CIR's, comparing the contours of the two CIR's, and/or computing normalized cross-correlation between the two CIR's. Based on the comparison result from module 108B, module 108C may determine whether the receival timestamp and the TOF result based on the data/ranging packet from the other UWB device should be accepted or rejected. In some embodiments, if the receival timestamp and the TOF result can be accepted, module 108C may compute the TOF for determining the distance between UWB device 102 and on-board computer 104.

FIG. 1C illustrates an exemplary architecture of on-board computer 104. As discussed above with respect to FIG. 1A, on-board computer 104 includes ranging controller application 134 as one of the controller applications installed in on-board computer 104. Ranging controller application 134 includes a module CIR obtaining unit 108D for computing a CIR, and a module CIR processing unit 108E for processing the CIR for transmission if needed. On-board computer 104 further includes a wireless interface 130 to facilitate wireless communication with UWB device 102 via wireless links. Ranging controller application 134 may utilize the wireless interface 130 as needed. Wireless interface 130 may facilitate at least bi-directional UWB communication, and in some embodiments, wireless interface 130 represents a hybrid wireless communication approach that combines UWB communication and one or more wireless communications other than UWB (e.g., Bluetooth, GPS, Wi-Fi, and cellular data connection).

For example, the module 108D may utilize a UWB chip in the wireless interface 130 to obtain CIR-related data (e.g., STS) from data/ranging packets transmitted by UWB device 102, and perform accumulation to generate an CIR based on the STS. Module 108E may process the CIR generated by module 108D for transmission, in some embodiments. Module 108E may further transmit the processed CIR via wireless interface 130. On-board computer 104 also includes a storage 111. The storage 111 stores program instructions, which, when executed by a processor of on-board computer 104 causes on-board computer 104 to run ranging controller application 134 according to the flows illustrated in the signaling diagrams discussed above. Storage 111 also stores predetermined processing ranges for processing the CIR. For example, the predetermined processing ranges include a predetermined range in time delay that captures the channel characteristics in the CIR. In some embodiments, the channel characteristics of a UWB channel include phase and amplitude information for paths (e.g., direct, reflected, refracted) that the UWB signal travelled in getting from the transmitter to the receiver.

In operation, on-board computer 104 may be ranging with UWB device 102. Module 108D may compute an CIR based on the data/ranging packet (e.g., STS) transmitted by the UWB device 102 using accumulation. In some embodiments, module 108D includes a cipher accumulator that generates the second CIR from the STS in a received data/ranging packet from UWB device 102, using a channel impulse analysis (CIA) algorithm. Module 108E may then process the second CIR to reduce its size and facilitate transmission. The second CIR may be processed using various means. For example, module 108 E may include software/hardware for compressing the second

CIR, truncating the second CIR (e.g., removing a noise portion or a less-of-interest portion of the second CIR data), and/or pre-computing the second CIR (e.g., pre-computing and transmitting a magnitude/strength of the second CIR data). In some embodiments, on-board computer 104 does not include module 108E, and may transmit the second CIR without processing (in its original form).

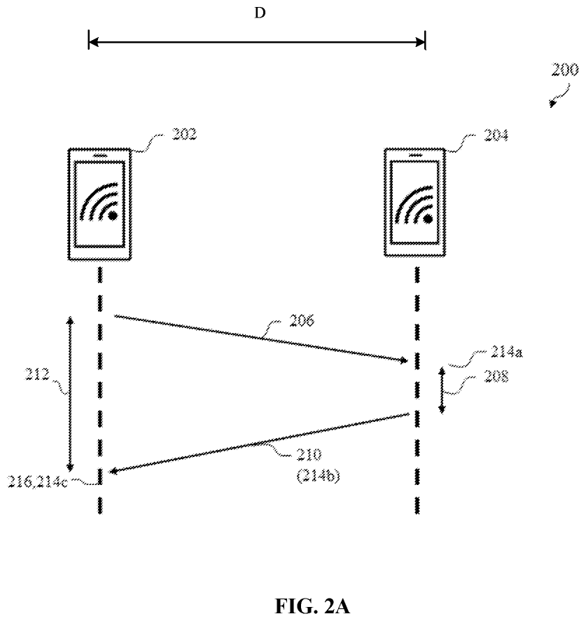

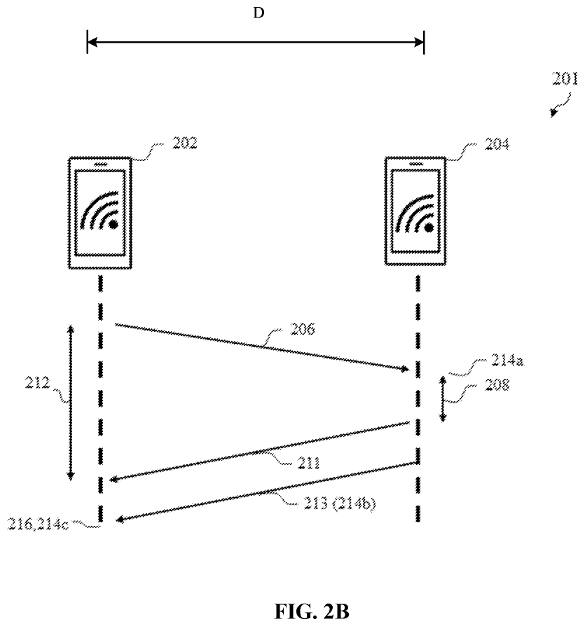

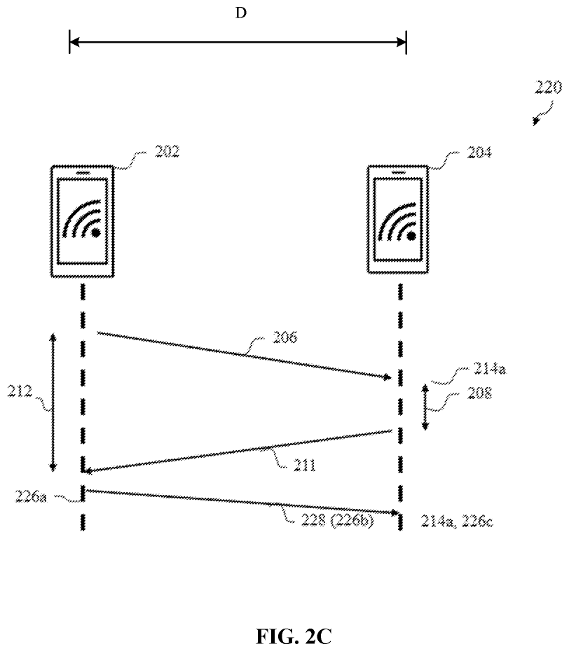

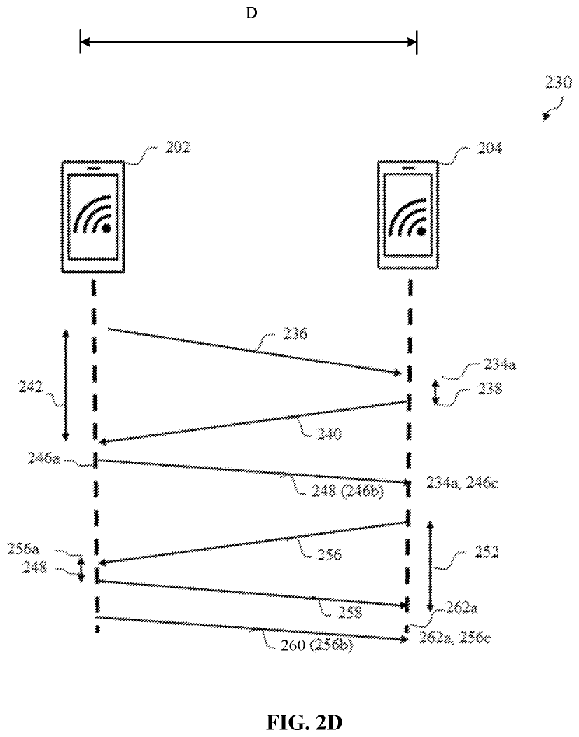

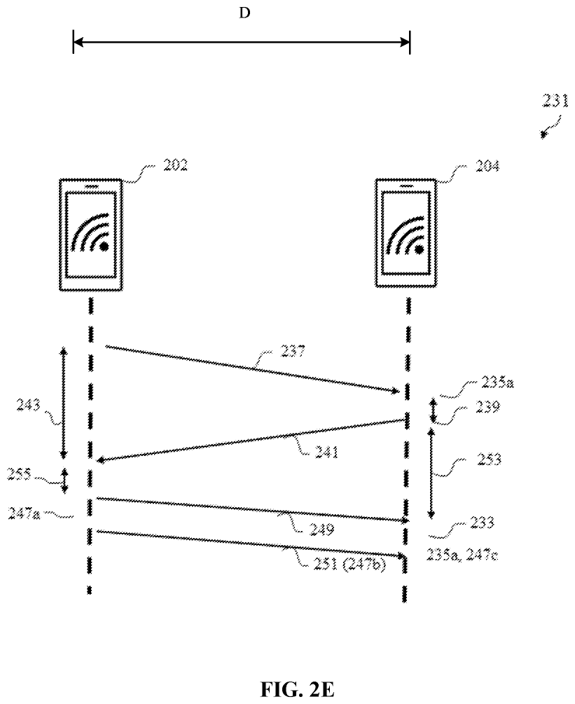

FIG. 2A shows an illustrative embodiment of two UWB devices in a UWB TWR system 200 performing SS TWR, according to some embodiments. System 200 may include a first UWB device 202 and a second UWB device 204. First UWB device 202 may be an example of UWB device 102, and second UWB device 204 may be an example of on-board computer 104.

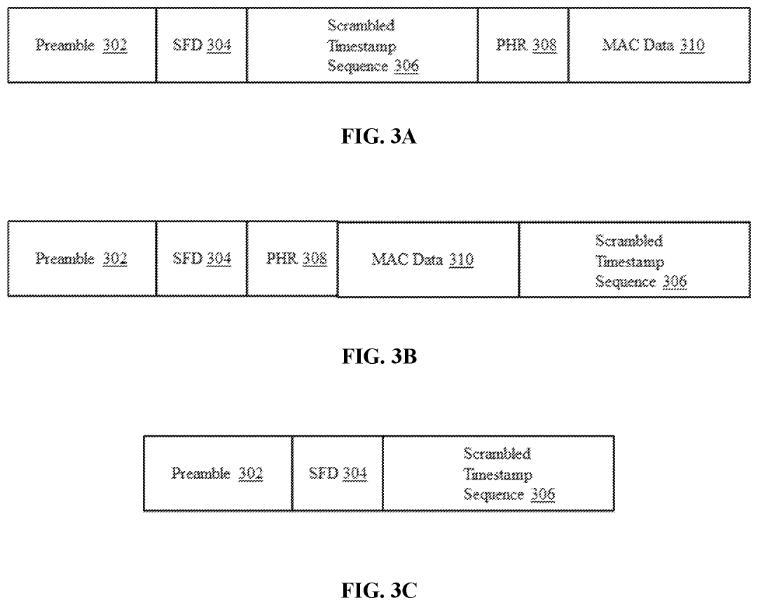

FIGS. 3A-3C illustrate different frame structures that can be used in the embodiments of the present disclosure. In FIGS. 3A-3C, preamble 302 (e.g., also referred as “sync”) represents a sync pattern that is a sequence of symbols forming a frame preamble, and may be based on a predefined code sequence having certain properties that make it useful for channel sounding purposes (including perfect periodic audio-correlation). Preamble 302 can be used to synchronize the sender and the receiver. SFD 304 represents start frame delimiter, which often consists of a fixed sequence that serves as a start pattern and marks the beginning of the frame. SFD 304 indicates the end of preamble 302 and the precise start of the switch to PHR 308. PHR 308 represents physical layer header and indicates the start of the actual data held in the data packet. PHR 308 contains information about the payload (e.g., MAC data 310). Scrambled timestamp sequence 306 represents a cipher sequence/code that is cryptographically generated bits. The cipher sequence often consists of pulses of pseudo-random polarity, which would not be repeatable or predictable. The cipher sequence can be generated by a cryptographically secure pseudorandom number generator. Mac data 310 represents the payload, e.g., actual data, transmitted in the data packet.

In operation, first UWB device 202 may transmit a first packet 206 (e.g., a ranging packet or a “poll”) containing a first STS. In some embodiments, the frame structure in FIG. 3C can be an example of first packet 206, according to some embodiments. For example, first packet 206 may include a first STS but no data.

Second UWB device 204 may receive first packet 206 and compute a first CIR 214a by accumulating (e.g., referring back to the description of module 108D) the first STS in first packet 206. In some embodiments, second UWB device 204 accumulates the first STS (e.g., scrambled timestamp sequence 306) using a CIA algorithm. In some embodiments, second UWB device 204 may also process first CIR 214a, forming a processed first CIR 214b, to facilitate transmission. For example, second UWB device 204 may compress first CIR 214a to a desired size for transmission. In another example, second UWB device 204 may truncate first CIR 214a to remove certain portions, e.g., low-level noise portion and/or portion of less interest, to reduce size while maintaining the characteristics of the RF channel between the two UWB devices. In a further example, second UWB device 204 may pre-compute and only transmit the strength/magnitude of first CIR 214a (e.g., without transmitting the phase data of first CIR 214a). After a time of reply 208 (e.g., T_{reply}, for data processing), second UWB device 204 may transmit a processed first CIR 214b in a second packet 210, which contains a second STS. In some embodiments, second packet 210 may have frame structures shown in FIGS. 3A and 3B, For example, second packet 210 may be a ranging packet that includes the second STS and data (e.g., the processed first CIR 214b, data conveying T_{reply}). In some embodiments, the processed first CIR 214b may be located in MAC data 310 of second packet 210.

First UWB device 202 may receive second packet 210 containing processed first CIR 214b and the second STS. The time from first UWB device 202 transmits first packet 206 to the time first UWB device 202 receives second packet 210 is a time of loop 212 (e.g., Tₗₒₒₚ). First UWB device 202 may compute a second CIR 216 by accumulating the second STS, and may recover/reconstruct first CIR 214a using processed first CIR 214b (e.g., referring back to the description of module 108A). The recovered first CIR 214c may reflect the characteristics of the RF channel between first UWB device 202 and second UWB device 204. In various embodiments, recovered first CIR 214c, reflecting the characteristics of the RF channel, can be the original form of first CIR 214a, part of the original form of first CIR 214a, or a modified form of first CIR 214a. First UWB device 202 may then compare recovered first CIR 214c and second CIR 216 (e.g., referring back to the description of module 108B), and determine the similarity between recovered first CIR 214c and second CIR 216. Based on the similarity, first UWB device 202 may determine whether the receival timestamp and TOF based on the receiving of second packet 210 should be adopted or rejected (e.g., referring back to the description of module 108C). In some embodiments, first UWB device 202 adopts the receival timestamp and calculates the TOF as (Tₗₒₒₚ-T_{reply})/2. The distance D between first UWB device 202 and second UWB device 204 may be calculated as D=TOF×speed of light.

FIG. 2B illustrates two UWB devices in a UWB TWR system 201 performing SS TWR, according to some embodiments. Different from system 200, in system 201, second UWB device 204 may send the second STS and processed first CIR 214b in separate packets. In some embodiments, second UWB device 204 transmits a second packet 211 (e.g., a ranging packet) that includes the second STS without data (e.g., without the first CIR). Second UWB device 204 may then send a third packet 213 (e.g., a data packet) that includes T_{reply} and processed first CIR 214b. T_{reply} may be the time of reply 208 between the receiving of first packet 206 and the transmission of second packet 211 by second UWB device 204, and the time of loop Tₗₒₒₚ 212 may be the time between the transmission of first packet 206 and the receiving of second packet 211 by first UWB device 202. In some embodiments, first UWB device 202 determines whether the calculated TOF should be accepted or rejected. The TOF may be calculated, by first UWB device 202, similar to that of UWB TWR system 200, and is not repeated herein.

FIG. 2C illustrates two UWB devices in a UWB TWR system 220 performing SS TWR, according to some embodiments. Different from systems 200 and 201, in system 220, second UWB device 204 may transmit a second packet 211 (e.g., a ranging packet) that includes the second STS without data (e.g., without the first CIR). First UWB device 202 may receive second packet 211 and generate a second CIR 226a by accumulating the second STS. First UWB device 202 may then send a third packet 228 (e.g., a data packet) that includes T_{reply} and a processed second CIR 226b to second UWB device 204. Upon receiving processed second CIR 226b, second UWB device 204 may recover processed second CIR 226b to generate a recovered second CIR 226c. In some embodiments, recovered second CIR 226c, reflecting the characteristics of the RF channel, can be the original form of second CIR 226a, part of the original form of second CIR 226a, or a modified form of second CIR 226a. Second UWB device 204 may then compare recovered second CIR 226c and first CIR 214a. T_{reply} may be the time of reply 208 between the receiving of first packet 206 and the transmission of second packet 211 by second UWB device 204, and the time of loop Tₗₒₒₚ 212 may be the time between the transmission of first packet 206 and the receiving of second packet 211 by first UWB device 202. In some embodiments, second UWB device 204 determines whether the calculated TOF should be accepted or rejected. The TOF may be calculated, by second UWB device 204, similar to that of UWB TWR system 200, and is not repeated herein.

FIG. 2D illustrates two UWB devices in a UWB TWR system 230 performing DS TWR, according to some embodiments. First UWB device 202 may transmit a first packet 236 (e.g., a ranging packet or a “poll”) including a first STS but without data to second UWB device 204. Second UWB device 204 may generate a first CIR 234a by accumulating the first STS. After a time of reply 238, second UWB device 204 may transmit a second packet 240 (e.g., a ranging packet) with a second STS but without data to first UWB device 202. Upon receiving second packet 240, first UWB device 200 may generate a second CIR 246a by accumulating the second STS. First UWB device 202 may then send a third packet 248 (e.g., a data packet) that includes Tₗₒₒₚ and a processed second CIR 246b to second UWB device 204. Upon receiving processed second CIR 246b, second UWB device 204 may recover processed second CIR 246b to generate a recovered second CIR 246c. In some embodiments, recovered second CIR 246c, reflecting the characteristics of the RF channel, can be the original form of second CIR 246a, part of the original form of second CIR 246a, or a modified form of second CIR 246a. Second UWB device 204 may then compare recovered second CIR 246c and first CIR 234a. T_{reply1} may be the time of reply 208 between the receiving of first packet 236 and the transmission of second packet 240 by second UWB device 204, and Tₗₒₒₚ₁ may be the time of loop 242 between the transmission of first packet 236 and the receiving of second packet 240 by first UWB device 202.

Further, second UWB device 204 may transmit a fourth packet 256 (e.g., a ranging packet or a “poll”) including a third STS but without data to first UWB device 202. First UWB device 202 may generate a third CIR 256a by accumulating the third STS. After a time of reply 248, first UWB device 202 may transmit a fifth packet 258 (e.g., a ranging packet) with a fourth STS but without data to second UWB device 204. Upon receiving fifth packet 258, second UWB device 200 may generate a fourth CIR 262a by accumulating the fourth STS. First UWB device 202 may also send a sixth packet 260 (e.g., a data packet) that includes T_{reply2} and a processed third CIR 256b to second UWB device 204. Upon receiving processed third CIR 256b, second UWB device 204 may recover processed third CIR 256b to generate a recovered third CIR 256c. In some embodiments, recovered third CIR 256c, reflecting the characteristics of the RF channel, can be the original form of third CIR 256a, part of the original form of third CIR 256a, or a modified form of third CIR 256a. Second UWB device 204 may then compare recovered third CIR 256c and fourth CIR 234a. T_{reply2} may be the time of reply 248 between the receiving of fourth packet 256 and the transmission of fifth packet 258 by first UWB device 202, and Tₗₒₒₚ₂ may be the time of loop 252 between the transmission of fourth packet 256 and the receiving of fifth packet 258 by second UWB device 204. In some embodiments, second UWB device 204 determines whether the calculated TOF should be accepted or rejected. The TOF may be calculated, by second UWB device 204, using TOF= (Tₗₒₒₚ₁×Tₗₒₒₚ₂−T_{reply1}×T_{reply2})/(Tₗₒₒₚ₁×Tₗₒₒₚ₂+T_{reply1}×T_{reply2}).

FIG. 2E illustrates two UWB devices in a UWB TWR system 231 performing DS TWR, according to some embodiments. First UWB device 202 may transmit a first packet 237 (e.g., a ranging packet or a “poll”) including a first STS but without data to second UWB device 204. Second UWB device 204 may generate a first CIR 235a by accumulating the first STS. After a time of reply 239, second UWB device 204 may transmit a second packet 241 (e.g., a ranging packet) with a second STS but without data to first UWB device 202. Upon receiving second packet 241, first UWB device 200 may generate a second CIR 247a by accumulating the second STS. First UWB device 202 may transmit a third packet 249 (e.g., a ranging packet) with a third STS but no data, to second UWB device 204. Second UWB device 204 may generate a third CIR 233 by accumulating the third STS. First UWB device 202 may also send a fourth packet 251 (e.g., a ranging packet) that includes Tₗₒₒₚ₁, T_{reply2}, and a processed second CIR 247b to second UWB device 204. Upon receiving processed second CIR 247b, second UWB device 204 may recover processed second CIR 247b to generate a recovered second CIR 247c. In some embodiments, recovered second CIR 247c, reflecting the characteristics of the RF channel, can be the original form of second CIR 247a, part of the original form of second CIR 247a, or a modified form of second CIR 247a. Second UWB device 204 may then compare recovered second CIR 247c, first CIR 235a, and the third CIR 233.

T_{reply1} may be the time of reply 239 between the receiving of second packet 237 and the transmission of second packet 241 by second UWB device 204, and Tₗₒₒₚ₁ may be the time of loop 243 between the transmission of first packet 237 and the receiving of second packet 241 by first UWB device 202. T_{reply2} may be the time of reply 255 between the receiving of second packet 241 and the transmission of third packet 249 by first UWB device 202, and Tₗₒₒₚ₂ may be the time of loop 253 between the transmission of second packet 241 and the receiving of third packet 249 by second UWB device 204. In some embodiments, second UWB device 204 determines whether the calculated TOF should be accepted or rejected. The TOF may be calculated, by second UWB device 204, using TOF=(Tₗₒₒₚ₁×Tₗₒₒₚ₂−T_{reply1}×T_{reply2})/(Tₗₒₒₚ₁×Tₗₒₒₚ₂+T_{reply1}×T_{reply2}).

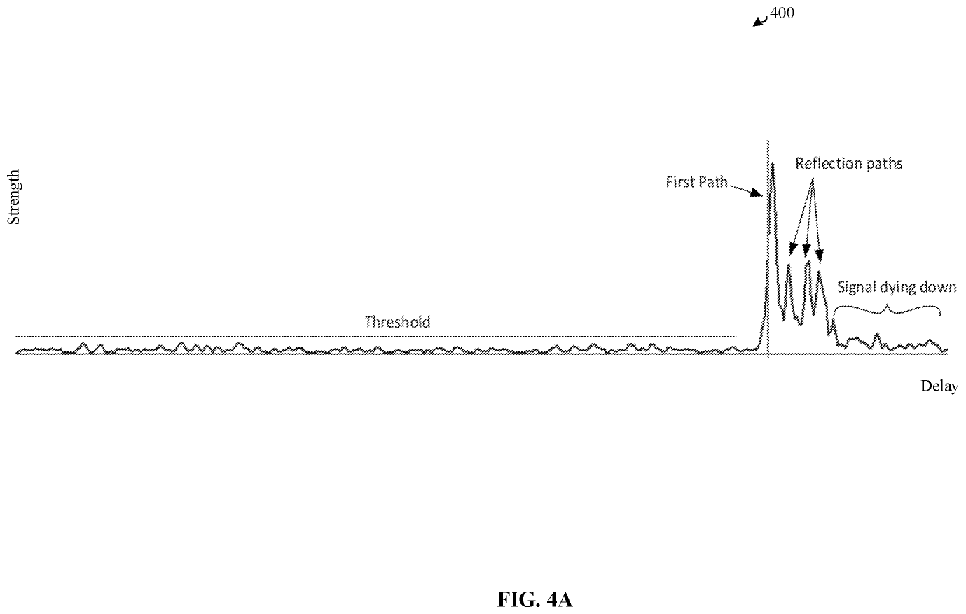

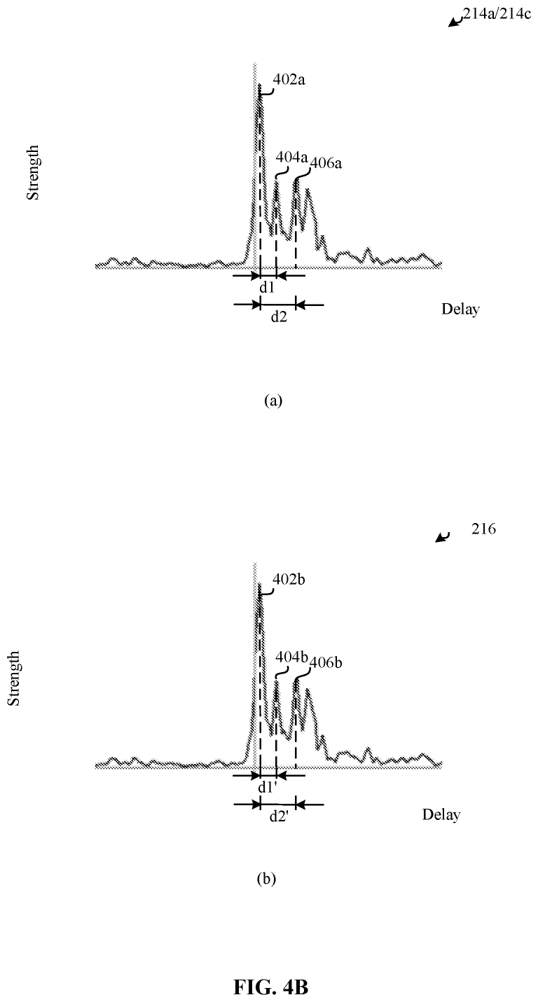

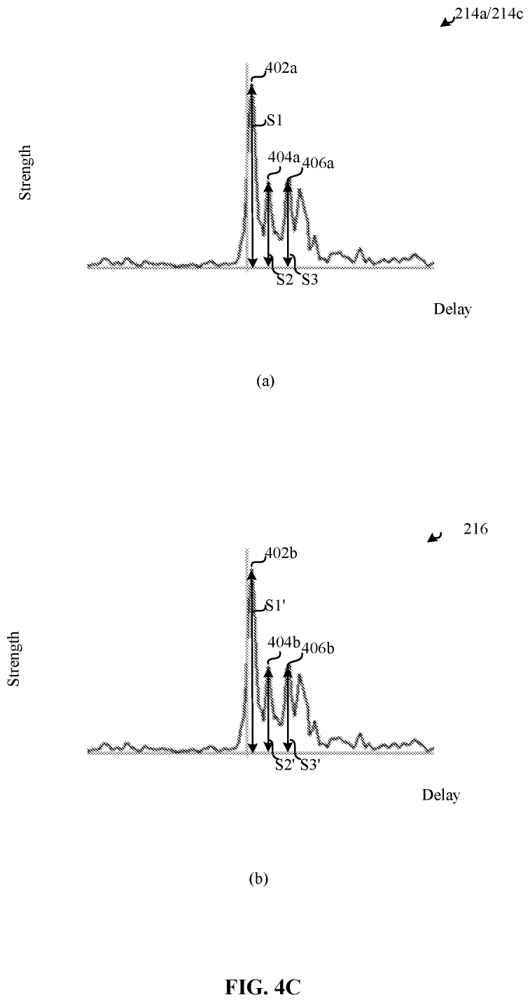

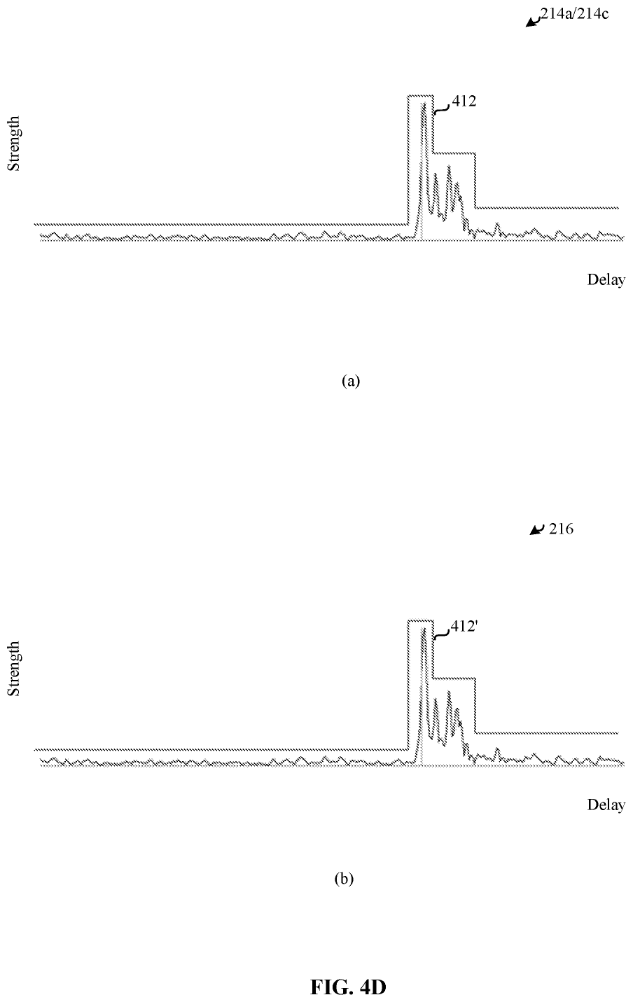

FIG. 4A illustrates a CIR 400 accumulated from a STS, according to some embodiments. CIR 400 includes an early-in-time portion that may be used to choose a baseline noise threshold (“Threshold”). CIR 400 also include a plurality of peaks reflecting the actual signal and its reflections. As shown in FIG. 4A, CIR 400 has a first peak rising above the baseline noise threshold. The first peak represents the “first path” of the signal and may be the highest level (strongest power/strength) peak in a line-of-sight scenario with reflection paths being lower. The “reflection paths” are shown as peaks with lower power/strength. In some embodiments, in non-line-of-sight (NLOS) scenarios (not shown), the first path may be attenuated by passing through some intervening body/solid and lower in power than a reflected signal (e.g., reflection path). For ease of illustration, the first path is shown as the first peak that as the highest power, and the reflection paths are shown as peaks of lower strengths following the first peak. The signal and reflections may die down after the reflection paths. CIR 400 may be an example of first CIR 214a and/or second CIR 216.

FIGS. 4B-4D illustrate various means for a UWB device (e.g., first UWB device 202 or second UWB device 204) to compare two CIR's (e.g., first CIR 214a/recovered first CIR 214c and second CIR 216). For case of illustration, FIGS. 4B-4D are illustrated in connection with FIG. 2A.

In some embodiments, first UWB device 202 may compare a first separation between a first peak and a second peak of first CIR 214a (or recovered first CIR 214c) with a second separation between a first peak and a second peak of second CIR 216. A separation is the time in the CIR which is a function of the sampling rate being used. As shown in FIG. 4B, first CIR 214a may include a first peak 402a representing the first path (from first UWB device 202 to second UWB device 204), and a second peak 404a and a third peak 406a representing reflection paths. Second CIR 216 may include a first peak 402b representing the first path (from second UWB device 204 to first UWB device 202), and a second peak 404b and a third peak 406b representing reflection paths. First UWB device 202 may determine the separation (e.g., in time delay) between two peaks in the respective CIR. For example, first UWB device 202 may determine a separation dl between first peak 402a and second peak 404a, a separation d2 between first peak 402a and third peak 406a, etc. First UWB device 202 may also determine a separation d1′ between first peak 402b and second peak 404b, a separation d2′ between first peak 402b and third peak 406b, etc.

First UWB device 202 may then compare separations, corresponding to the peaks of the same paths, in both CIR's. In some embodiments, first UWB device 202 may compare dl with d1′ and determine whether d1 and d1′ are sufficiently similar. For example, first UWB device 202 may determine whether the difference between dl and d1′ is within a predetermined percentage (e.g., 1%, 3%, 10%, etc.) of d1' (or d1), e.g., similarity equal to or higher than 99%, 97%, 90%, etc. The predetermined percentage may be stored in a memory/storage (e.g., similar to storage 109) of first UWB device 202. In some embodiments, first UWB device 202 may also compare d2 with d2,′ e.g., by determining whether the difference between d2 and d2′ is within a predetermined percentage of d2′ (or d2′). In some embodiments, first UWB device 202 may also compare the separations between two peaks of reflection paths, such as the second peak (404a/404b) and the third peak (406a/406b) in the two CIR's, using similar method. In some embodiments, the resolution and tolerance of the comparisons may depend on the sampling rates of first UWB device 202 and/or second UWB device 204. In various embodiments, the comparisons described may be used separately or jointly in a CIR validation process. For example, first UWB device 202 may compare one or more separations and determine whether the similarity is sufficiently high. In an embodiment, first UWB device 202 compares at least two separations and determines the similarity between the two CIR's is sufficiently high if both of the separations reach at least a predetermined percentage (e.g., 95%).

In some embodiments, first UWB device 202 may compare a first ratio between a strength of a first peak and a strength of a second peak of first CIR 214a (or recovered first CIR 214c) with a second ratio between a strength of a first peak and a strength of a second peak of second CIR 216. As shown in FIG. 4C, of first CIR 214a, a strength of first peak 402a is S1, a strength of second peak 404a is S2, and a strength of third peak 406a is S3; and of second CIR 216, a strength of first peak 402b is S1′, a strength of second peak 404b is S2′, and a strength of third peak 406b is S3′. A first ratio may be S1/S2 or S1/S3, and a second ratio may be S1′/S2′ or S1′/S3′. First UWB device 202 may compare S1/S2 with S1′/S2′, or compare S1/S3 with S1′/S3′. In some embodiments, first UWB device 202 may determine whether the first ratio (e.g., S1/S2 or S1/S3) and the second ratio (e.g., S1′/S2′ or S1′/S3′) are sufficiently similar. For example, first UWB device 202 may determine whether the difference between the first ratio and the second ratio is within a predetermined percentage (e.g., 1%, 3%, 10%, etc.) of the second ratio (or the first ratio) e.g., similarity equal to or higher than 99%, 97%, 90%, etc. In some embodiments, first ratio also includes S2/S3 and second ratio also includes S2′/S3′, and similar method may be used to determine the similarity between the first ratio and the second ratio. In some embodiments, UWB device 202 computes at least two first ratios, at least two second ratios, and compares them correspondingly. For example, first UWB device 202 may compare two first ratios and two second ratios and determine whether their respective similarity is sufficiently high. In an embodiment, first UWB device 202 compares the two first ratios with the two second ratios, and determines the similarity between the two CIR's is sufficiently high if the similarity of both ratios reach at least a predetermined percentage (e.g., 95%). In some embodiments, the predetermined percentage may be stored in a memory/storage (e.g., similar to storage 109) of first UWB device 202.

In some embodiments, first UWB device 202 may compare a contour of the first CIR with a contour of the second CIR. As shown in FIG. 4D, first UWB device 202 may define a contour line 412 (e.g., a mask or an envelope) covering first CIR 214a (or recovered first CIR 214c) or a contour line 412′ covering second CIR 216. Each contour line may follow the shape of the respective CIR and have a respective tolerance for the respective CIR. For example, each contour line may include one or more steps each higher than a highest peak over its coverage by no more than a predetermined percentage of the peak. For example, the first peak of a respective CIR may be covered by one step, and the rest of the peaks (e.g., reflection paths) may be covered by another step. In some embodiments, first UWB device 202 may first generate contour line 412′ that covers second CIR 216, and may normalize first CIR 214a such that a first peak of first CIR 214a aligns with the first peak of second CIR 216. For example, the first peak of first CIR 214a may be normalized to have the same strength as the first peak of second CIR 216. First UWB device 202 may map the first peaks of first CIR 214a and second CIR 216 and determine whether first CIR 214a falls into contour line 412′. In some embodiments, first UWB device 202 determines the similarity between first CIR 214a and second CIR 216 by determining whether a difference between first CIR 214a and contour line 412′ is within a predetermined percentage of contour line 412′, (e.g., 1%, 3%, 10%, etc.) of contour line 412′, e.g., similarity equal to or higher than 99%, 97%, 90%, etc.

In some embodiment, to improve security, first UWB device 202 may repeat the mentioned process by swapping first CIR 214a and second CIR 216. For example, first UWB device 202 may generate contour line 412 that covers first CIR 214a, and may normalize second CIR 216 such that a first peak of second CIR 216 aligns with the first peak of first CIR 214a. For example, the first peak of second CIR 216 may be normalized to have the same strength as the first peak of first CIR 214a. First UWB device 202 may map the first peaks of first CIR 214a and second CIR 216 and determine whether second CIR 216 falls into contour line 412. In some embodiments, first UWB device 202 determines the similarity between first CIR 214a and second CIR 216 by determining whether a difference between second CIR 216 and contour line 412 is within a predetermined percentage of contour line 412. In some embodiments, the order described above may change. For example, first UWB device 202 may first normalize second CIR 216 to map to contour line 412, and then normalize first CIR 214a to map to contour line 412′. In some embodiments, only one normalization and mapping is performed. The predetermined percentages of contour lines 412 and 412′ may be stored in first UWB device 202 (e.g., in a memory similar to storage 109).

In some embodiments, although not shown, first UWB device 202 may compare the similarity of the two CIR's by computing a normalized cross-correlation value between the two CIR's. For example, first UWB device 202 may compute a normalized cross-correlation value between first CIR 214a (or recovered first CIR 214c) and second CIR 216, and compare the normalized cross-correlation value with a predetermined threshold correlation value stored in first UWB device 202 (e.g., in a memory similar to storage 109). In some embodiments, first UWB device 202 determines the similarity between first CIR 214a and second CIR 216 by determining whether a difference between the computed normalized cross-correlation value with the predetermined threshold correlation value is within a predetermined percentage (e.g., 1%, 3%, 10%, etc.) of the predetermined threshold correlation value, e.g., similarity equal to or higher than 99%, 97%, 90%, etc.

In some embodiments, the CIR validation processed described above may be used independently/separately or jointly. In some embodiments, the comparisons are performed using a partial or an entirety of each CIR. For example, a contour line covers only a portion of the respective CIR (e.g., the portion with the peaks and exclusive of the baseline noise threshold) that reflects the channel characteristics. The portion may also be a predetermined portion of interest, e.g., the portion of the respective CIR in a predetermined time span after the arrival of the first peak. In another example, the normalized cross-correlation may be performed between portions of the two CIR's, e.g., exclusive of the base noise threshold and/or the portion of the respective CIR in a predetermined time span after the arrival of the first peak.

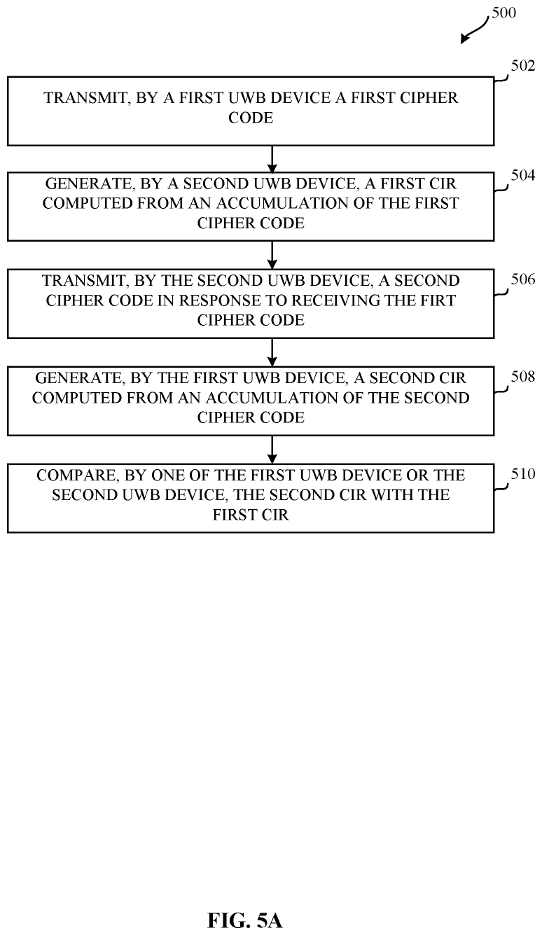

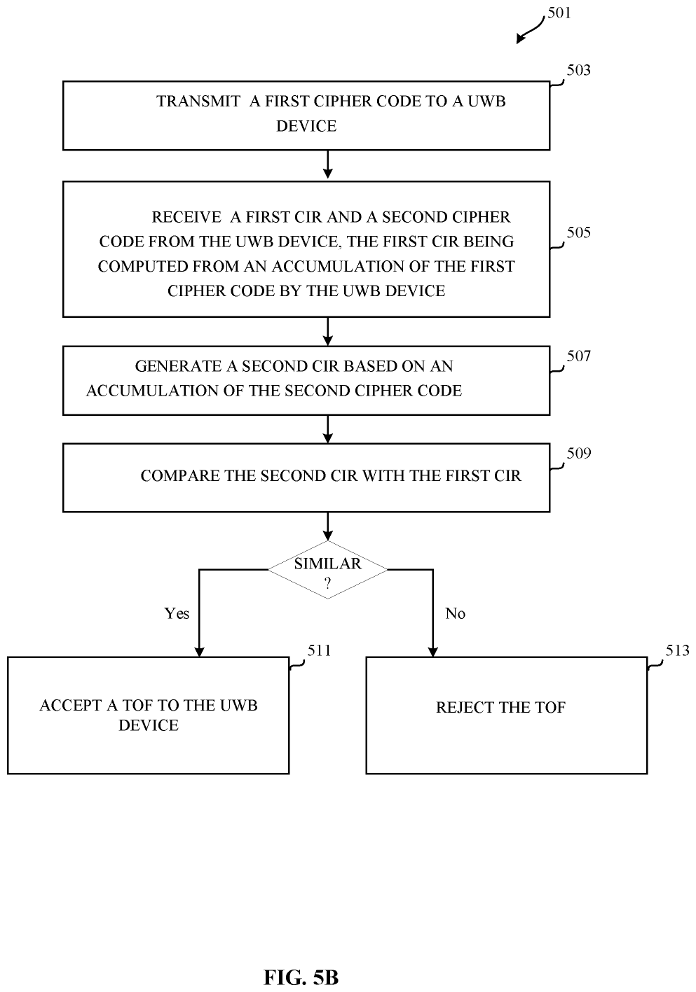

FIG. 5A is a flowchart of a method 500 for TWR in a UWB system, according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. FIG. 5A is illustrated in view of the interaction between two UWB devices, and each of the two UWB devices perform a respective part of the interaction. Method 500 also supports the operation from the standpoint of each of the UWB devices. For ease of illustration, FIG. 5A is described in connection with FIGS. 2 and 4A-4D.

At step 502, a first UWB device transmits a first cipher code. Referring back to FIGS. 2A-2E, first UWB device 202 may transmit a first packet 206/236/237 having a first STS.

At step 504, a second UWB device generates a first CIR computed from an accumulation of the first cipher code. Referring back to FIGS. 2A-2E, second UWB device 204 may compute first CIR 214a/234a/235a from the accumulation of the first STS in first packet 206.

At step 506, the second UWB device transmits a second cipher code in response to receiving the first cipher code. Referring back to FIGS. 2A-2E, second UWB device 204 may transmit a second cipher code in a packet 210/213/211/240/241

At step 508, the first UWB device generates a second CIR computed from an accumulation of the second cipher code. Referring back to FIGS. 2A-2E, first UWB device 202 may compute a second CIR 216/226a/246a/247a from the accumulation of the second STS of second packet 210.

At step 510, the first UWB device or the second UWB device compares the second CIR with the first CIR. Referring back to FIGS. 2A-2E and FIGS. 4A-4D, first UWB device 202 or second UWB device 204 may compare second CIR 216/226a/246a/247a with first CIR 214a/234a/235a (or the recovered formed of the first CIR) to determine whether the receival timestamp and the TOF result should be adopted or rejected.

FIG. 5B is a flowchart of a method 501 for TWR by a UWB device, according to some embodiments of the present disclosure. Method 501 is merely an example, and is not intended to limit the present disclosure beyond what is explicitly recited in the claims. Additional operations can be provided before, during, and after the method 501, and some operations described can be replaced, eliminated, or moved around for additional embodiments of method 501. For ease of illustration, FIG. 5B is described in connection with FIGS. 2A, 2B and 4A-4D.

At step 503, a first data packet having a first cipher code is transmitted to a UWB device. Referring back to FIGS. 2A and 2B, first UWB device 202 transmits a first packet 206, having a first STS, to a second UWB device 204.

At step 505, a first CIR and a second cipher code are received from the UWB device, the first CIR being computed from an accumulation of the first cipher code by the UWB device. Referring back to FIGS. 2A and 2B, first UWB device 202 may receive first CIR 214a and a second STS from second UWB device 204. First CIR 214a may be computed from an accumulation of the first STS by second UWB device 204. In some embodiments, first CIR 214a may be processed for transmission, and first UWB device 202 may receive a processed first CIR 214b.

At step 507, a second CIR is generated based on an accumulation of the second cipher code. Referring back to FIGS. 2A and 2B, first UWB device 202 generates second CIR 216 based on accumulation of the second STS of second packet 210.

At step 509, the second CIR is compared with the first CIR. Referring back to FIGS. 2A and 2B and 4A-4D, first UWB device 202 may compare second CIR 216 with first CIR 214a (or processed first CIR 214b).

At step 511, if a similarity between the first CIR and the second CIR is equal to or above a similarity threshold value, a TOF to the UWB device is accepted (e.g., being treated as valid). Referring back to FIGS. 2A and 2B, if first UWB device 202 determines first CIR 214a and second CIR 216 are sufficiently similar, first UWB device 202 may compute and accept the TOF between first UWB device 202 and second UWB device 204.

At step 513, if the similarity between the first CIR and the second CIR is below the similarity threshold value, the second data packet is rejected. Referring back to FIGS. 2A and 2B, if first UWB device 202 determines first CIR 214a and second CIR 216 are not sufficiently similar, first UWB device 202 may reject the TOF (or the receival timestamp of data packet 210), e.g., treating the TOF as invalid.

Those skilled in the art will recognize improvements and modifications to the preferred embodiments of the present disclosure. All such improvements and modifications are considered within the scope of the concepts disclosed herein and the claims that follow.

What is claimed is:

1. A method for channel impulse response (CIR) validation for two-way ranging (TWR) in an ultra-wide band (UWB) communication system, the method comprising:
receiving, from a UWB device, a first cipher code;
generating a first CIR corresponding to characteristics of a UWB channel from an accumulation of the first cipher code;
transmitting, to the UWB device, a second cipher code in response to receiving the first cipher code;
receiving, from the UWB device, a second CIR computed from an accumulation of the second cipher code; and
comparing the second CIR with the first CIR.

2. The method of claim 1, further comprising:
in response to a similarity between the first CIR and the second CIR being equal to or above a similarity threshold value, accepting a time-of-flight (TOF) between the first UWB device and the second UWB device; and
in response to the similarity between the first CIR and the second CIR being below the similarity threshold value, rejecting the TOF.

3. The method of claim 1, further comprising transmitting the first CIR to the UWB device, wherein the first CIR and the second cipher code are transmitted in in separate packets.

4. The method of claim 1, further comprising transmitting the first CIR to the UWB device, wherein the second cipher code and the first CIR are transmitted in a same packet.

5. The method of claim 1, wherein the comparing of the second CIR with the first CIR comprises:
comparing a first separation between a first peak and a second peak of the first CIR with a second separation between a first peak and a second peak of the second CIR, wherein the similarity threshold value comprises a predetermined percentage of the second separation.

6. The method of claim 5, wherein:
the first peak of each of the first CIR and the second CIR represents a first path peak; and
the second peak of each of the first CIR and the second CIR represents a reflection path peak of a same time location.

7. The method of claim 1, wherein the comparing of the second CIR with the first CIR comprises:
comparing a first ratio between a strength of a first peak and a strength of a second peak of the first CIR with a second ratio between a strength of a first peak and a strength of a second peak of the second CIR, wherein the similarity threshold value comprises a predetermined percentage of the second ratio.

8. The method of claim 7, wherein:
the first peaks of the first CIR and the second CIR correspond to a same first time location; and
the second peaks of the first CIR and the second CIR correspond to a same second time location.

9. The method of claim 1, wherein the comparing of the second CIR with the first CIR comprises:
comparing a contour of the first CIR with a contour of the second CIR, wherein the similarity threshold value comprises a predetermined percentage of a contour line that covers the second CIR.

10. The method of claim 9, comprising:
generating the contour line that completely covers the second CIR;
normalizing the first CIR such that a first peak of the first CIR aligns with a first peak of the second CIR; and
mapping the first CIR into the contour line.

11. The method of claim 10, wherein the similarity threshold value further comprises a second predetermined percentage of a second contour line that covers the first CIR, the method further comprising:
generating the second contour line that completely covers the first CIR;
normalizing the second CIR such that the first peak of the second CIR aligns with the first peak of the first CIR; and
mapping the second CIR into the second contour line.

12. The method of claim 1, wherein the comparing of the second CIR with the first CIR comprises:
computing, by the one of the first UWB device or the second UWB device, a normalized cross-correlation value between the first CIR and the second CIR; and
comparing, by the one of the first UWB device or the second UWB device, the normalized cross-correlation value with the similarity threshold value, wherein the similarity threshold value is a predetermined threshold correlation value.

13. The method of claim 1, wherein the second CIR has a reduced size at least one of data compression,
discarding a noise portion of the second CIR, or
pre-computing a magnitude of the second CIR.

14. A method for channel impulse response (CIR) validation for two-way ranging (TWR) in an ultra-wide band (UWB) communication system, the method comprising:
transmitting a first cipher code to a UWB device;
receiving a second cipher code from the UWB device;
generating a first CIR corresponding to characteristics of a UWB channel from an accumulation of the second cipher code;
receiving, from the UWB device, a second CIR computed from an accumulation of the first cipher code; and
comparing the second CIR with the first CIR.

15. The method of claim 14, further comprising:
in response to a similarity between the first CIR and the second CIR being equal to or above a similarity threshold value, accepting a time-of-flight (TOF) between the first UWB device and the second UWB device; and
in response to the similarity between the first CIR and the second CIR being below the similarity threshold value, rejecting the TOF.

16. The method of claim 14, further comprising transmitting the first CIR to the UWB device.

17. The method of claim 14, wherein the comparing of the second CIR with the first CIR comprises:
comparing a first separation between a first peak and a second peak of the first CIR with a second separation between a first peak and a second peak of the second CIR, wherein the similarity threshold value comprises a predetermined percentage of the second separation.

18. The method of claim 17, wherein:
the first peak of each of the first CIR and the second CIR represents a first path peak; and
the second peak of each of the first CIR and the second CIR represents a reflection path peak of a same time location.

19. The method of claim 14, wherein the comparing of the second CIR with the first CIR comprises:
comparing a first ratio between a strength of a first peak and a strength of a second peak of the first CIR with a second ratio between a strength of a first peak and a strength of a second peak of the second CIR, wherein the similarity threshold value comprises a predetermined percentage of the second ratio.

20. An ultra-wide band (UWB) device for two-way ranging (TWR), comprising:
a transceiver operable to perform a UWB communication;
a memory for storing program instructions, cipher codes, and channel-impulse responses accumulated from the cipher codes; and
a processor coupled to the transceiver and to the memory, wherein the processor is operable to execute the program instructions, which, when executed by the processor, cause the UWB device to perform the following operations:
receiving, from another UWB device, a first cipher code;
generating a first CIR corresponding to characteristics of a UWB channel from an accumulation of the first cipher code; and
transmitting, to the other UWB device, a second cipher code corresponding to the characteristics of UWB channel in response to receiving the first cipher code.
